(19) United States
(12) Patent Application Publication
(10) Pub. No.: US 2019/0205835 A1
(43) Pub. Date: Jul. 4, 2019

(54) REFRIGERATION MANAGEMENT SYSTEM

(71) Applicant: Carrier Corporation, Palm Beach Gardens, FL (US)

(72) Inventors: Robert A. Chopko, Baldwinsville, NY (US); Marc Beasley, Beverly, MA (US); Ciara Poolman, Syracuse, NY (US)

(21) Appl. No.: 16/311,903

(22) PCT Filed: Jun. 13, 2017
(86) PCT No.: PCT/US2017/037149

§ 371 Date: Dec. 20, 2018

Related U.S. Application Data
(60) Provisional application No. 62/352,341, filed on Jun. 20, 2016.

(51) Int. Cl. G06Q 10/08

(52) U.S. Cl. CPC G06Q 10/08355; G06Q 10/0832; G06Q 10/0838; G06Q 10/087; G06Q 10/0833

(57) ABSTRACT

A method and system for managing a downstream refrigeration system in response to an upstream refrigeration system includes storing upstream data from the upstream refrigeration system, determining a present goods condition corresponding to the upstream data, determining a desired goods condition corresponding to the present goods condition, determining downstream parameters corresponding to the desired goods condition, and providing the downstream parameters to the downstream refrigeration system.

### DESCRIPTION OF RELATED ART

The subject matter disclosed herein relates to cold chain distribution systems, and to a system and method for managing multiple refrigeration systems.

Typically, cold chain distribution systems are used to transport and distribute temperature sensitive and perishable goods. For example, products such as food and pharmaceuticals may be susceptible to temperature, humidity, contaminants, and other environmental factors. Advantageously, cold chain systems allow perishable and environmentally sensitive goods to be effectively transported and distributed without damage or other undesirable effects.

However, goods may be transferred from various refrigeration systems during transportation and distribution. Various environmental characteristics and good characteristics may affect the quality of the goods. A system and method that can manage multiple refrigeration systems in response to upstream refrigeration systems is desired.

### BRIEF SUMMARY

According to an embodiment, a method for managing a downstream refrigeration system in response to an upstream refrigeration system includes storing upstream data from the upstream refrigeration system, determining a present goods condition corresponding to the upstream data, determining a desired goods condition corresponding to the present goods condition, determining downstream parameters corresponding to the desired goods condition, and providing the downstream parameters to the downstream refrigeration system.

In addition to one or more of the features described above, or as an alternative, further embodiments could include determining a present goods condition corresponding to at least one goods parameter.

In addition to one or more of the features described above, or as an alternative, further embodiments could include that the at least one goods parameter includes at least one packaging parameter.

In addition to one or more of the features described above, or as an alternative, further embodiments could include identifying the upstream refrigeration system, and identifying the downstream refrigeration system.

In addition to one or more of the features described above, or as an alternative, further embodiments could include receiving upstream data from the upstream refrigeration system via at least one upstream sensor.

In addition to one or more of the features described above, or as an alternative, further embodiments could include determining a desired goods condition corresponding to a selected priority parameter.

In addition to one or more of the features described above, or as an alternative, further embodiments could include that the upstream refrigeration system is a transport refrigeration system.

In addition to one or more of the features described above, or as an alternative, further embodiments could include that the upstream refrigeration system is a stationary refrigeration system.

In addition to one or more of the features described above, or as an alternative, further embodiments could include that the downstream refrigeration system is a transport refrigeration system.

In addition to one or more of the features described above, or as an alternative, further embodiments could include that the downstream refrigeration system is a stationary refrigeration system.

In addition to one or more of the features described above, or as an alternative, further embodiments could include providing the downstream parameters to a user device.

According to an embodiment, a refrigeration management system for managing a downstream refrigeration system in response to an upstream refrigeration system includes a processor, and a memory comprising computer-executable instructions that, when executed by the processor, cause the processor to perform operations, the operations including storing upstream data from the upstream refrigeration system, determining a present goods condition corresponding to the upstream data, determining a desired goods condition corresponding to the present goods condition, determining downstream parameters corresponding to the desired goods condition, and providing the downstream parameters to the downstream refrigeration system.

According to an embodiment, a computer program product tangibly embodied on a computer readable medium, the computer program product including instructions that, when executed by a processor, cause the processor to perform operations includes storing upstream data from the upstream refrigeration system, determining a present goods condition corresponding to the upstream data, determining a desired goods condition corresponding to the present goods condition, determining downstream parameters corresponding to the desired goods condition, and providing the downstream parameters to the downstream refrigeration system.

Technical function of the embodiments described above includes determining a present goods condition corresponding to the upstream data, determining a desired goods condition corresponding to the present goods condition, and determining downstream parameters corresponding to the desired goods condition.

Other aspects, features, and techniques of the embodiments will become more apparent from the following description taken in conjunction with the drawings.

### BRIEF DESCRIPTION OF THE SEVERAL VIEWS OF THE DRAWINGS

The subject matter is particularly pointed out and distinctly claimed in the claims at the conclusion of the specification. The foregoing and other features, and advantages of the embodiments are apparent from the following detailed description taken in conjunction with the accompanying drawings in which like elements are numbered alike in the several FIGURES:

FIG. 1 illustrates a schematic view of a cold chain system suitable for use with a refrigeration management system;

FIG. 2 is a flow diagram of a cold chain distribution network; and

FIG. 3 is a flow diagram of a method of managing multiple refrigeration units.

### DETAILED DESCRIPTION

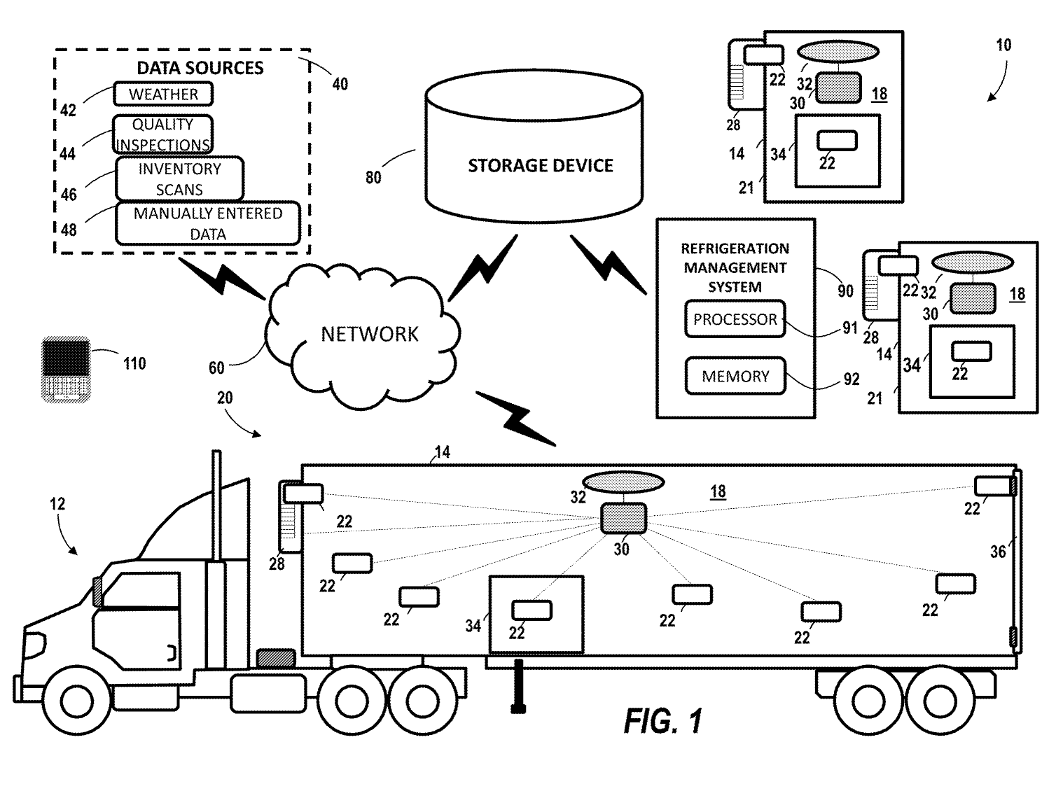

Referring now to the drawings, FIG. 1 shows a cold chain distribution system 10 to transport goods 34. In the illustrated embodiment, the cold chain distribution system 10 includes multiple refrigerated systems 20, 21, a storage device 80, and a refrigeration management system 90. In the illustrated embodiment, goods 34 can be transferred between various stationary and mobile refrigerated systems 20, 21 to be distributed as desired. In the illustrated embodiment, the refrigeration management system 90 can utilize information from upstream refrigerated systems 20, 21 to control parameters within downstream refrigerated systems 20, 21. Advantageously, the refrigeration management system 90 can modify parameters within refrigerated systems 20, 21 to enhance quality of the goods 34, save energy within the refrigerated systems 20, 21, etc.

Transport refrigeration system 20 is used to transport and distribute perishable goods and environmentally sensitive goods (herein referred to as perishable goods 34). It is understood that embodiments described herein may be applied to shipping goods that are not perishable. The perishable goods 34 may include but are not limited to fruits, vegetables, grains, beans, nuts, eggs, dairy, seed, flowers, meat, poultry, fish, ice, blood, pharmaceuticals, or any other suitable cargo requiring cold chain transport.

In the illustrated embodiment, the cold chain distribution system 10 can further include stationary refrigeration systems 21. In the illustrated embodiment, stationary refrigeration systems 21 can be representative of producer's storage, distribution centers, stores, consumer storage, etc. In certain embodiments, goods 34 can be transported between stationary refrigeration systems 21 via transport refrigeration systems 20. In certain embodiments, environmental parameters of upstream refrigeration systems 20, 21 can affect parameters of the goods 34. In certain embodiments, downstream refrigeration systems 20, 21 can be adjusted to compensate to maintain or improve the quality of the goods 34 or achieve other objectives.

In the illustrated embodiment, the refrigeration systems 20, 21 include an environmentally controlled container 14 with a refrigeration unit 28 for climate control of perishable goods 34. In certain embodiments, the container 14 of the transport refrigeration system 20 may be pulled by a tractor 12. It is understood that embodiments described herein may be applied to shipping containers that are shipped by rail, sea, or any other suitable container, without use of a tractor 12. The container 14 may define an interior compartment 18.

In the illustrated embodiment, the refrigeration unit 28 is associated with a container 14 to provide desired environmental parameters, such as, for example temperature, pressure, humidity, carbon dioxide, ethylene, ozone, light exposure, vibration exposure, and other conditions to the interior compartment 18. In further embodiments, the refrigeration unit 28 is a refrigeration system capable of providing a desired temperature and humidity range. In the illustrated embodiment, refrigeration unit 28 of the refrigeration systems 20, 21 can be controlled by refrigeration management system 90 using short range communication, long range communication, etc. In certain embodiments, control of the refrigeration unit 28 can include duty cycles, target temperature, target humidity, etc.

In the illustrated embodiment, the refrigeration systems 20, 21 include sensors 22. The sensors 22 may be utilized to monitor parameters internal and external to the container 14. The parameters monitored by the sensors 22 may include, but are not limited to, temperature, pressure, humidity, carbon dioxide, ethylene, ozone, light exposure, vibrations, and other conditions in the interior compartment 18. Accordingly, suitable sensors 22 are utilized to monitor the desired parameters. Sensors 22 may be selected for certain applications depending on the type of perishable goods 34 to be monitored and the corresponding environmental sensitivities. In an embodiment, temperatures are monitored. As seen in FIG. 1, the sensors 22 may be placed directly on the perishable goods 34.

Further, as in the illustrated embodiment, sensors 22 may be used to monitor various parameters of the refrigeration systems 20, 21. These sensors 22 may be placed in a variety of locations including, but not limited to, on the refrigeration unit 28, on a door 36 of the container 14 and throughout the interior compartment 18. The sensors 22 may be placed directly within the refrigeration unit 28 to monitor the performance of the refrigeration unit 28. Individual components internal to the refrigeration unit 28 may also be monitored by sensors 22 to detect performance aspects, such as, for example usage cycles, duration, temperatures and pressure of individual components. As seen, the sensors 22 may also be placed on the door 36 of the container 14 to monitor the position of the door 36. Whether the door 36 is open or closed affects both the temperature of the container 14 and the perishable goods 34. For instance, in hot weather, an open door 36 will allow cooled air to escape from the container 14, causing the temperature of the interior compartment 18 to rise, thus affecting the temperature of the perishable goods 34. Additionally, a global positioning system (GPS) location may also be detected by the sensors 22. The GPS location may help in providing time-based location information for the perishable goods 34 that will help in tracking the travel route and other parameters along that route. For instance, the GPS location may also help in providing information from data sources 40 regarding weather 42 experienced by the container 14 along the travel route. The local weather 42 affects the temperature of the container 14 and thus may affect the temperature of the perishable goods 34.

As illustrated in FIG. 1, the refrigeration systems 20, 21 may further include a controller 30 configured to log data from the sensors 22 at a selected sampling rate. The controller 30 may be enclosed within the refrigeration unit 28 or separate from the refrigeration unit 28 as illustrated. The data may further be augmented with time, location stamps or other relevant information. In the illustrated embodiment, the controller 30 can receive instructions via the communication module 32 to control the operation of the refrigeration unit 28. The controller 30 may also include a processor (not shown) and an associated memory (not shown). The processor may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium.

In an illustrated embodiment, the refrigeration systems 20, 21 may include a communication module 32 in operative communication with the controller 30 and in wireless operative communication with a network 60. The communication module 32 is configured to transmit data to the network 60 via wireless communication. The wireless communication may be, but is not limited to, radio, microwave, cellular, satellite, or another wireless communication method. The network 60 may be but is not limited to satellite networks, cellular networks, cloud computing network, wide area network, or another type of wireless network. The communication module 32 may include a short range interface, wherein the short range interface includes at least one of: a wired interface, an optical interface, and a short range wireless interface.

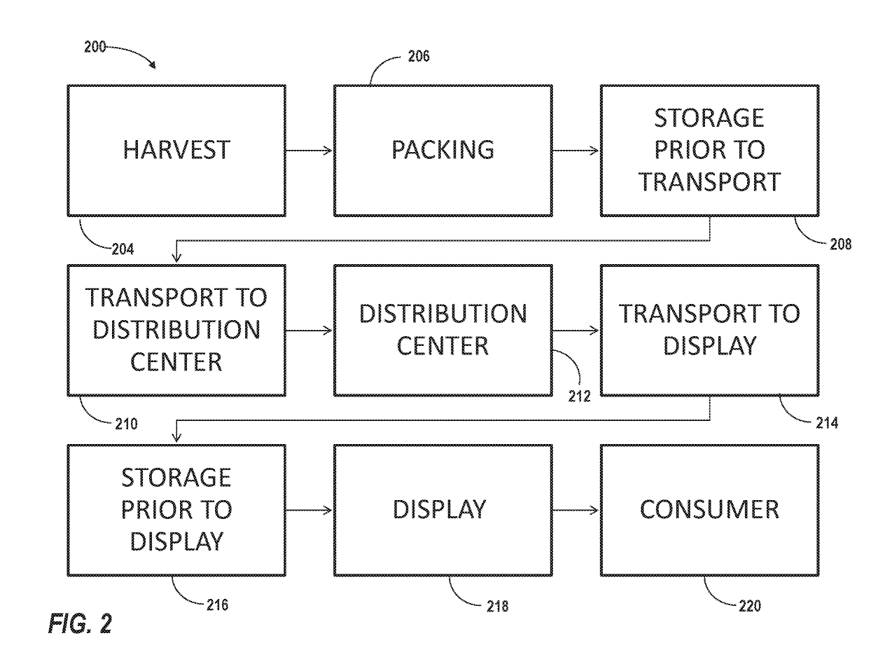

Data may also be provided by data sources 40, as illustrated in FIG. 1. These data sources 40 may be collected at any point throughout the cold chain distribution network 200, which as illustrated in FIG. 2 may include harvest 204, packing 206, storage prior to transport 208, transport to distribution center 210, distribution center 212, transport to display 214, storage prior to display 216, display 218 and consumer 220. These stages are provided for illustrative purposes and a distribution chain may include fewer stages or additional stages, such as, for example a cleaning stage, a processing stage, and additional transportation stages. It is understood that the cold chain distribution system 200 is exemplary, and a variety of other stages may be included.

Referring to FIG. 1, the data sources 40 may include, but are not limited to, weather 42, quality inspections 44, inventory scans 46, and manually entered data 48. The weather 42, as discussed above, has an effect on the operation of the refrigeration unit 28 of the refrigeration systems 20, 21 by influencing the temperature of the container 14 but the weather 42 also has other influences on the refrigeration unit 28. Moreover, quality inspections 44, similar to the weather 42, may reveal data of the perishable goods. Quality inspections 44 may be done by a machine or a human being. Quality inspections 44 performed by a machine may be accomplished using a variety of techniques including but not limited to optical, odor, soundwave, infrared, or physical probe.

Further inventory scans 46, may also reveal data about the perishable goods 34 interesting to the consumer and may help in tracking the perishable goods 34. For instance, the inventory scan 46 may reveal the time, day, truck the perishable goods arrived on, packaging, packaging condition, etc. In the illustrated embodiment, packaging parameters can be utilized to determine thermal characteristics and environmental sensitivities of the goods 34. For example, well insulated packaging may allow goods 34 to withstand greater temperature variances, while damaged packaging may diminish the goods 34 ability to withstand temperature variances. While the system 10 includes sensors 22 to aid in automation, often times the need for manual data entry is unavoidable. The manually entered data 48 may be input via a variety of devices including but not limited to a cellular phone, tablet, laptop, smartwatch, a desktop computer or any other similar data input device.

Data collected throughout each stage of the cold chain distribution system 200 may include environment conditions experienced by the perishable goods 34 such as, for example, temperature, pressure, humidity, carbon dioxide, ethylene, ozone, vibrations, light exposure, weather, time and location. For instance, strawberries may have experienced an excessive shock or were kept at 34° F. during transport. Data may further include attributes of the perishable goods 34 such as, for example, temperature, weight, size, sugar content, maturity, grade, ripeness, labeling, and packaging. For instance, strawberries may be packaged in 1 pound clamshells, be a certain weight or grade, be organic, and have certain packaging or labels on the clamshells. Data may also include information regarding the operation of the environmental control unit 28, as discussed above. The data may further be augmented with time, location stamps or other relevant information.

In the illustrated embodiment, the system 10 further includes a storage device 80 to store the cold chain data acquired along the cold chain distribution network. The storage device 80 may be, but is not limited to, a random access memory (RAM), read only memory (ROM), or other electronic, optical, magnetic or any other computer readable medium. Storage device 80 may be embedded in network 60 (e.g., cloud based storage) or be a remote system accessible via network 60.

In the illustrated embodiment, the system 10 further includes a refrigeration management system 90. The refrigeration management system 90 may also include a processor 91 and an associated memory 92. The processor 91 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 92 may be but is not limited to a random access memory (RAM), read only memory (ROM), or other electronic, optical, magnetic or any other computer readable medium. In operation, processor 91 executes computer program instructions in the memory 92 to execute the operations describe herein.

In the illustrated embodiment, the refrigeration management system 90 can identify a path for goods 34 along the cold chain distribution path, identify refrigeration systems 20, 21 upstream and downstream of a good 34 current location, analyze the condition of the goods 34, and control downstream refrigeration systems 20, 21. In certain embodiments, the refrigeration management system 90 can maintain quality of the goods 34, while reducing total energy cost or decreasing transport time. Advantageously, the refrigeration management system 90 can operatively interconnect refrigeration systems 20, 21 to allow upstream conditions to affect downstream refrigeration parameters. In certain embodiments, the refrigeration management system 90 can be executed as a cloud based software as a service.

In the illustrated embodiment, the refrigeration management system 90 can identify a current location of goods 34 using a combination of manually entered data and sensor 22 data received from the refrigeration systems 20, 21. Using knowledge of the cold chain distribution path 200, the refrigeration management system 90 can identify the current location of the goods 34 as well as refrigeration systems 20, 21 upstream of the goods 34 location (identified as upstream refrigeration systems 20, 21) and the refrigeration systems 20, 21 downstream of the current goods 34 location (identified as downstream refrigeration systems 20, 21).

In the illustrated embodiment, the refrigeration management system 90 can receive sensor inputs from upstream refrigeration systems 20, 21 as well as parameters from goods 34 via sensors 22 as well as other data sources 40. The parameters monitored by the sensors 22 may include, but are not limited to, temperature, pressure, humidity, carbon dioxide, ethylene, ozone, light exposure, vibrations, and other conditions in the interior compartment 18. Accordingly, suitable sensors 22 are utilized to monitor the desired parameters. Additionally, characteristics of the goods 34 can be identified, such as the environmental sensitivities, insulating characteristics, and current quality of the goods 34. Further, data can be stored in the storage device 80 or directly retrieved from the upstream refrigeration units 20, 21.

In the illustrated embodiment, sensor 22 readings and other information regarding the goods 34 can be analyzed to determine a current condition of the goods 34. For example, the refrigeration management system 90 may determine that the upstream refrigeration systems 20, 21 may not have sufficiently cooled the goods 34 to a desired cooling window. Further, in certain embodiments, the refrigeration management system 90 can consider that certain goods 34 may be more sensitive to cooling ranges due to product characteristics or due to packaging characteristics. As a result, the current quality or condition of the goods 34 can be determined based off of historical models, look up tables, etc.

In the illustrated embodiment, the refrigeration management system 90 can assess the current condition of the goods 34 and further determine if corrective or preventative actions should be taken to maintain the integrity of the goods 34. In the illustrated embodiment, the quality of the goods 34 can be forecasted or otherwise modeled to determine the predicted effects of future environmental parameters or modifications. For example, if the goods 34 were previously not adequately cooled in an upstream refrigeration system 20, 21, the refrigeration management system 90 may determine that further cooling is necessary. Further, the refrigeration management system 90 may determine that goods 34 are of satisfactory condition and do not require any corrective actions.

In the illustrated embodiment, the refrigeration management system 90 can identify desired downstream refrigeration system 20, 21 parameters to modify to maintain or improve goods 34 quality. The refrigeration management system 90 can calculate and provide corrective or preventative parameters to the downstream refrigeration systems 20, 21 based on various priority parameters. In the illustrated embodiment, priority parameters can include maximizing good 34 quality, energy savings, minimizing transport time, minimizing inventory. In certain embodiments, the refrigeration management system 90 can apply multiple priority parameters when determining downstream refrigeration system 20, 21 parameters.

In certain embodiments, the refrigeration management system 90 can adjust downstream parameters such as refrigeration unit 28 parameters, as well as reroute transport refrigeration systems 20, adjust residence times in stationary refrigeration systems 21, etc. The refrigeration management system 90 can further analyze capabilities of refrigeration systems 20, 21. Advantageously the refrigeration management system 90 can be reactive to failures, unforeseen conditions, etc.

In the illustrated embodiment, adjustments to parameters for the downstream refrigeration systems 20, 21 can be automatically executed or manually executed. In certain embodiments, operational parameters can be transmitted to the refrigeration systems 20, 21 via network 60. In other embodiments, instructions or parameters can be transmitted to a user via a user device 110. User devices 110 can include a phone, tablet, computer, etc. to receive instructions from the refrigeration management system 90. In certain embodiments, the user device 110 can further transmit priorities and current operating conditions to the refrigeration management system 90.

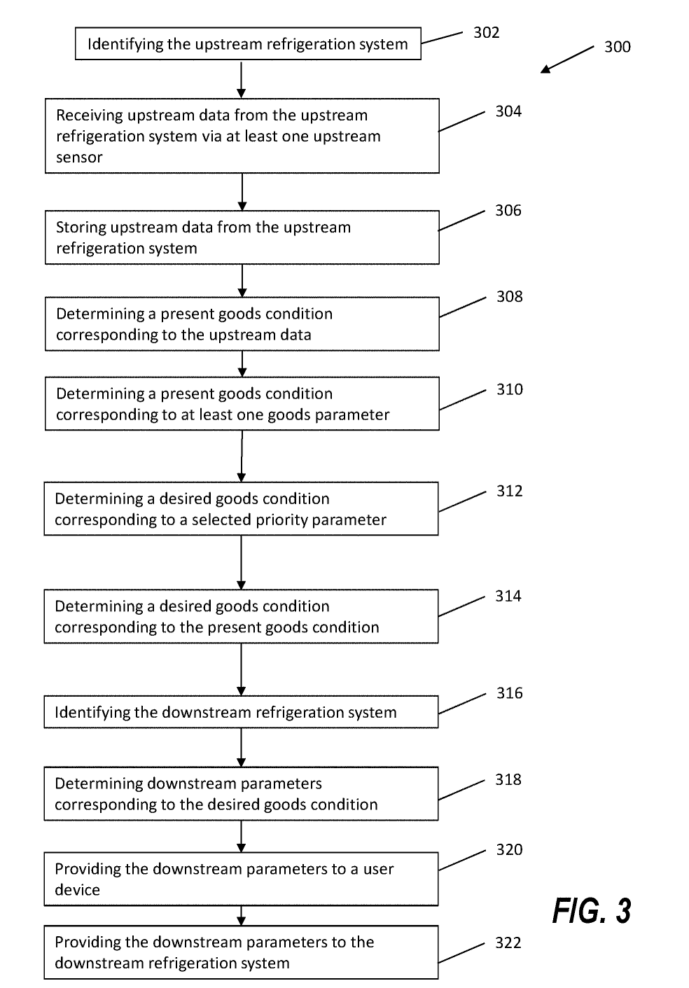

Referring to FIG. 3, a method 300 for managing refrigeration systems is illustrated. In operation 302, the upstream refrigeration system is identified. In the illustrated embodiment, the refrigeration management system can identify a current location of goods using a combination of manually entered data and sensor data received from the refrigeration systems. Using knowledge of the cold chain distribution path, the refrigeration management system can identify the current location of the goods as well as refrigeration systems upstream of the goods location.

In operation 304, upstream data is received from the upstream refrigeration system via at least one upstream sensor. The parameters monitored by the sensors may include, but are not limited to, temperature, pressure, humidity, carbon dioxide, ethylene, ozone, light exposure, vibrations, and other conditions in the interior compartment. Accordingly, suitable sensors are utilized to monitor the desired parameters. Additionally, characteristics of the goods can be identified, such as the environmental sensitivities, insulating characteristics, and current quality of the goods. In operation 306, upstream data from the upstream refrigeration system is stored.

In operation 308, a present goods condition corresponding to the upstream data is determined. For example, the refrigeration management system may determine that the upstream refrigeration systems may not have sufficiently cooled the goods to a desired cooling window.

In operation 310, a present goods condition corresponding to at least one goods parameter is determined. In certain embodiments, the refrigeration management system can consider that certain goods may be more sensitive to cooling ranges due to product characteristics or due to packaging characteristics. As a result, the current quality or condition of the goods can be determined based off of historical models, look up tables, etc.

In operation 312, a desired goods condition corresponding to a selected priority parameter is determined. The refrigeration management system can calculate and provide corrective or preventative parameters to the downstream refrigeration systems based on various priority parameters. In the illustrated embodiment, priority parameters can include maximizing good quality, energy savings, minimizing transport time, minimizing inventory. In certain embodiments, the refrigeration management system can apply multiple priority parameters when determining downstream refrigeration system parameters.

In operation 314, a desired goods condition corresponding to the present goods condition is determined. In the illustrated embodiment, the refrigeration management system 90 can assess the current condition of the goods and further determine if corrective or preventative actions should be taken to maintain the integrity of the goods. In the illustrated embodiment, the quality of the goods can be forecasted or otherwise modeled to determine the predicted effects of future environmental parameters or modifications.

In operation 316, the downstream refrigeration system is identified. Using knowledge of the cold chain distribution path, the refrigeration management system can identify the current location of the goods as well as the refrigeration systems downstream of the current goods location.

In operation 318, downstream parameters corresponding to the desired goods condition are determined. In the illustrated embodiment, the refrigeration management system can identify desired downstream refrigeration system parameters to modify to maintain or improve goods quality.

In operation 320, the downstream parameters are provided to a user device. User devices can include a phone, tablet, computer, etc. to receive instructions from the refrigeration management system.

In operation 322, the downstream parameters are provided to the downstream refrigeration system. In the illustrated embodiment, adjustments to parameters for the downstream refrigeration systems can be automatically executed or manually executed. In certain embodiments, operational parameters can be transmitted to the refrigeration systems via a network.

As described above, the exemplary embodiments can be in the form of processor-implemented processes and devices for practicing those processes, such as refrigeration management system 90. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes a device for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the exemplary embodiments. When implemented on a general-purpose microprocessor, the computer program code segments configure the microprocessor to create specific logic circuits.

The terminology used herein is for the purpose of describing particular embodiments only and is not intended to be limiting of the embodiments. While the description of the present embodiments has been presented for purposes of illustration and description, it is not intended to be exhaustive or limited to the embodiments in the form disclosed. Many modifications, variations, alterations, substitutions or equivalent arrangement not hereto described will be apparent to those of ordinary skill in the art without departing from the scope of the embodiments. Additionally, while various embodiments have been described, it is to be understood that aspects may include only some of the described embodiments. Accordingly, the embodiments are not to be seen as limited by the foregoing description, but are only limited by the scope of the appended claims.

What is claimed is:

1. A method for managing a downstream refrigeration system in response to an upstream refrigeration system, the method comprising:
storing upstream data from the upstream refrigeration system;
determining a present goods condition corresponding to the upstream data;
determining a desired goods condition corresponding to the present goods condition;
determining downstream parameters corresponding to the desired goods condition; and
providing the downstream parameters to the downstream refrigeration system.

2. The method of claim 1, further comprising determining the present goods condition corresponding to at least one goods parameter.

3. The method of claim 2, wherein the at least one goods parameter includes at least one packaging parameter.

4. The method of claim 1, further comprising:
identifying the upstream refrigeration system; and
identifying the downstream refrigeration system.

5. The method of claim 1, further comprising receiving upstream data from the upstream refrigeration system via at least one upstream sensor.

6. The method of claim 1 further comprising determining the desired goods condition corresponding to a selected priority parameter.

7. The method of claim 1, wherein the upstream refrigeration system is a transport refrigeration system.

8. The method of claim 1, wherein the upstream refrigeration system is a stationary refrigeration system.

9. The method of claim 1, wherein the downstream refrigeration system is a transport refrigeration system.

10. The method of claim 1, wherein the downstream refrigeration system is a stationary refrigeration system.

11. The method of claim 1, further comprising providing the downstream parameters to a user device.

12. A refrigeration management system for managing a downstream refrigeration system in response to an upstream refrigeration system, the system comprising:
a processor; and
a memory comprising computer-executable instructions that, when executed by the processor, cause the processor to perform operations, the operations comprising:
storing upstream data from the upstream refrigeration system;
determining a present goods condition corresponding to the upstream data;
determining a desired goods condition corresponding to the present goods condition;
determining downstream parameters corresponding to the desired goods condition; and
providing the downstream parameters to the downstream refrigeration system.

13. A computer program product tangibly embodied on a computer readable medium, the computer program product including instructions that, when executed by a processor, cause the processor to perform operations comprising:
storing upstream data from the upstream refrigeration system;
determining a present goods condition corresponding to the upstream data;
determining a desired goods condition corresponding to the present goods condition;
determining downstream parameters corresponding to the desired goods condition; and
providing the downstream parameters to the downstream refrigeration system.
